(19) United States
(12) Patent Application Publication
(10) Pub. No.: US 2012/0171444 A1
(43) Pub. Date: Jul. 5, 2012

(54) TRANSPARENT FILM AND SURFACE-PROTECTION FILM USING SAID FILM

(75) Inventors: Hiromoto Haruta, Ibaraki-shi (JP); Masato Yamagata, Ibaraki-shi (JP); Kenjiro Niimi, Ibaraki-shi (JP); Natsuki Ukei, Ibaraki-shi (JP); Junko Nakano, Ibaraki-shi (JP); Tsutomu Shimura, Ibaraki-shi (JP); Hironobu Machinaga, Ibaraki-shi (JP)

(73) Assignee: NITTO DENKO CORPORATION, Osaka (JP)

(21) Appl. No.: 13/383,703

(22) PCT Filed: Jul. 9, 2010
(86) PCT No.: PCT/JP2010/061695

§ 371 Date: Mar. 26, 2012

(30) Foreign Application Priority Data
Jul. 15, 2009 (JP) 2009-167208

(51) Int. Cl. B32B 7/02; B32B 27/06; C09J 7/02

(52) U.S. Cl. 428/217; 428/336

(57) ABSTRACT

A transparent film whose back-face has excellent resistance to scratch, and a surface protection film having the transparent film are provided. A transparent film has a substrate layer formed of a transparent resin material, and a back-face layer with a thickness of 1 μm or less provided on a first face thereof. In a scratch test of the transparent film, the failure initiation load of the back-face layer is 50 mN or greater and the friction coefficient of the back-face layer is 0.4 or less.

### TECHNICAL FIELD

The present invention relates to a transparent film that is not easily scratch-marked on the back-face and a surface protection film provided with such a film. The present application claims priority based on Japanese Patent Application No. 2009-167208 filed on Jul. 15, 2009, the contents of which are incorporated herein in its entirety by reference.

### BACKGROUND ART

A surface protection film (also referred to as a surface protection sheet) in general has a constitution in which a pressure-sensitive adhesive (PSA) is provided over a film-shaped support. Such a protection film is bonded matchingly to an adherend through the PSA and thereby used with the purpose of protecting the adherend from scratches and dirt during processing, transport and the like. For instance, a polarizer that is bonded matchingly to a liquid crystal cell in the manufacturing of a liquid crystal display panel is manufactured once in the morphology of a roll, then unwound from this roll and cut to the desired size according to the shape of the liquid crystal cell and used. Here, in order to prevent the polarizer from being scratched by friction with a transport roll, or the like, in an intermediate step (for instance, a transport step during manufacturing of the polarizer in the roll morphology, during use of the polarizer, or the like), a measure is taken, of bonding a surface protection film matchingly to one face or both faces (typically one face) of the polarizer. The following Patent Documents 1 and 2 may be cited as technical documents related to surface protection films.

### PRIOR ART

### Patent Document

[Patent document 1] Japanese Patent Application Publication No. 2003-320631
[Patent document 2] Japanese Patent Application Publication No. 2005-314563

### DISCLOSURE OF THE INVENTION

### Problem to be Solved by the Invention

Transparent ones are preferably used as such surface protection films, given that an inspection of the external appearance of the adherend (for instance polarizer) may be carried out with the film left bonded thereto. In recent years, from such point of view as the ease of performance of the external appearance inspection, the level of requirement towards the quality level of the external appearance of the surface protection film has been raising. In particular, the quality of not being readily scratch-marked on the back-face of the surface protection film (the face on the opposite side from the face that is bonded to the adherend) is sought. The reason is that if a scratch mark is present on the surface protection film, whether this scratch is a scratch from the adherend or a scratch from the surface protection film cannot be assessed while the surface protection film is left in a bonded state.

Thus, an object of the present invention is to provide a transparent film that cannot be readily scratch-marked on the back-face (that is to say, having excellent resistance to scratch) and therefore is suitable for an application such as a support in a surface protection film. Another object of the present invention is to provide a surface protection film of a constitution having a PSA layer on one face of such a transparent film.

### Means for Solving the Problem

The transparent film provided by the present invention has a substrate layer formed of a transparent resin material and a back-face layer provided on a first face of the substrate layer. The back-face layer has a thickness of 1 μm or less. The transparent film has a failure initiation load of 50 mN or greater in a scratch test for the back-face layer, and the back-face layer exhibits a friction coefficient friction of 0.4 or less.

A transparent film of such a constitution can use the back-face layer to give the substrate layer a satisfactory resistance to scratch. A transparent film having excellent resistance to scratch in this way is suitable as a support of a surface protection film, given that an inspection of the external appearance of a product may be carried out accurately through the film. In addition, as the back-face layer has a small thickness, there is little influence exerted on the properties of the substrate layer (optical properties, dimensional stability and the like), which is desirable. In addition, if the thickness of the back-face layer is exceedingly greater than 1 μm, when the back-face layer contains a component that is prone to being colored, the coloration of the entirety of the transparent film may stand out, and when cure shrinkage arises accompanying the formation of the back-face layer, the transparent film may become prone to curling due to the shrinkage. Reducing the thickness of the back-face layer to within a range where the desired capability (for instance resistance to scratch) is realized is also desirable from the point that the coloration or curling may be prevented or attenuated. As resin materials constituting the substrate layer, those having as a base resin a polyester resin such as polyethylene terephthalate resin, polyethylene naphthalate resin, or the like, may be preferably adopted.

In one preferred mode of the art disclosed herein, the ratio between the plasticity index Ps of the back-face layer and the plasticity index Pb of the substrate layer (Ps/Pb; hereinafter also referred to as “plasticity index ratio”) of the transparent film is 1.5 or greater (that is to say, Ps/Pb≧1.5). Here, the plasticity index Ps of the back-face layer is determined by indenting the back-face layer constituting the transparent film perpendicularly with a Berkovich-type diamond indenter having a tip curvature radius of 0.1 μm, and measuring an indentation modulus and hardness at a depth of 10 nm and then dividing the elastic modulus by the hardness. In addition, the plasticity index ratio of the substrate layer is determined by indenting a substrate layer having no a back-face layer perpendicularly with the indenter, and measuring an indentation modulus and hardness at a depth of 10 nm and then dividing the elastic modulus by the hardness.

When a scratch-stress applied from above the back-face layer reaches the substrate layer and the substrate layer deforms, a transparent film satisfying the plasticity index ratio can deform adequately following the deformation of the substrate layer, as the back-face layer has a greater plasticity index than the substrate layer. Since this prevents a rupture of the back-face layer by the scratch-stress (that is to say, the failure initiation load becomes higher), a transparent film satisfying the failure initiation load and having excellent resistance to scratch may be appropriately realized.

It is desirable for the transparent film disclosed herein that the peel strength (back-face peel strength) is 2 N/19 mm or greater as measured by bonding a PSA tape to the back-face layer and peeling the PSA tape from the back-face layer under the conditions of 0.3 m/minute peel speed and 180 degrees peel angle. A transparent film demonstrating such a peel strength is adequate as a support of a surface protection film. That is to say, a surface protection film that has finished serving the role of protection is peeled-off and removed from the adherend (for instance, an optical member such as a polarizer). In so doing, bonding a PSA tape on the back-face of the surface protection film (the surface of the back-face layer) and pulling the PSA tape to separate an extremity of the surface protection film from the adherend allows the workability when removing the surface protection film to be improved and at the same time the burden imposed on the adherend to be attenuated. A surface protection film having the transparent film as a support is suited to the peeling operation that uses a PSA tape, since the back-face layer has an adequate degree of peel strength.

From the points of view of strength and productivity, or the like, a monolayer structure is desirable as a structure for the back-face layer. In addition, it is desirable that the back-face layer is provided on a first face of the substrate layer. With a constitution in which one, two or more intermediate layers are intercalated between the back-face layer and the substrate layer, sometimes the adhesiveness of the intermediate layer to the substrate layer and the back-face layer is insufficient and the failure initiation load of the back-face layer becomes prone to decreasing (the resistance to scratch decreases). Consequently, in order to realize the failure initiation load disclosed herein, adopting a constitution in which a back-face layer is provided directly on the substrate layer is advantageous.

In one preferred mode, the back-face layer comprises a resin material containing a lubricant. Lubricant herein refers to a component that, by being mixed in the resin material, has the action of decreasing the coefficient of friction thereof. According to the back-face layer comprising a resin material containing a lubricant in this manner, realizing the preferred coefficient of friction disclosed herein is facilitated and therefore realizing a transparent film having excellent resistance to scratch is facilitated, which is desirable.

In one preferred mode, the back-face layer comprises a resin material containing an antistatic component. With a transparent film of such constitution, the back-face layer can be utilized to confer resistance to scratch and antistatic properties. Accordingly, the productivity of the transparent film is better compared to a constitution in which the antistatic layer is provided separately from the back-face layer. In addition, the adhesiveness between the back-face layer and the substrate layer can be raised compared to a constitution in which an antistatic layer is intercalated between the back-face layer and the substrate layer, such that realizing a transparent film meeting the failure initiation load and having excellent resistance to scratch is facilitated. Given that providing both satisfactory antistatic properties and high resistance to scratch is straightforward, an electrically conductive polymer can be adopted preferably as the antistatic component.

The present invention additionally provides a surface protection film provided with any transparent film disclosed herein as a support. The surface protection film is typically provided with the transparent film and a PSA layer provided on the surface that is on the opposite side from the back-face layer of the transparent film. Such a surface protection film is in particular suitable as a surface protection film for optical parts.

### BRIEF DESCRIPTION OF THE DRAWINGS

FIG. 1 is a cross sectional view showing an example of constitution of a surface protection film according to the present invention.

FIG. 2 is a cross sectional view showing another example of constitution of a surface protection film according to the present invention.

FIG. 3 is a light microscopy image showing an example of scratch trace.

FIG. 4 is a schematic explanatory figure showing a method for measuring the failure initiation load.

### BEST MODE FOR CARRYING OUT THE INVENTION

Preferred embodiments of the present invention will be described below. Matters other than the particulars specifically alluded to herein, which are matters required in carrying out the present invention, may be understood as design particulars based on prior art in the relevant field by a person of ordinary skill in the art. The present invention can be carried out based on the contents disclosed herein and general knowledge in the relevant field.

In addition, embodiments described in the figures are schematized in order to describe the present invention clearly and do not represent accurately the size or the scale of the transparent film or the surface protection film of the present invention actually provided as a product.

Having excellent resistance to scratch, the transparent film disclosed herein may be used preferably in the support of a PSA sheet and other applications. Such a PSA sheet, in general, may be of a morphology referred to as PSA tape, PSA label, PSA film and the like. Among these, being suitable as a support in a surface protection film and given that inspection of the external appearance of a product may be carried out accurately through the film, the transparent film is suitable in particular as a support in a surface protection film for protecting, during fabrication or during transport of an optical part, the surface of the optical part (for instance, an optical part used as a liquid crystal display panel constituent such as a polarizer or a wave plate). The surface protection film disclosed herein is characterized by having a PSA layer on one face of the transparent film. While the PSA layer is typically formed continuously, there is no limitation to such a morphology, and the PSA layer may be formed for instance in a regular or a random pattern of dots, stripes, or the like. In addition, the surface protection film disclosed herein may be in roll form or in sheet form.

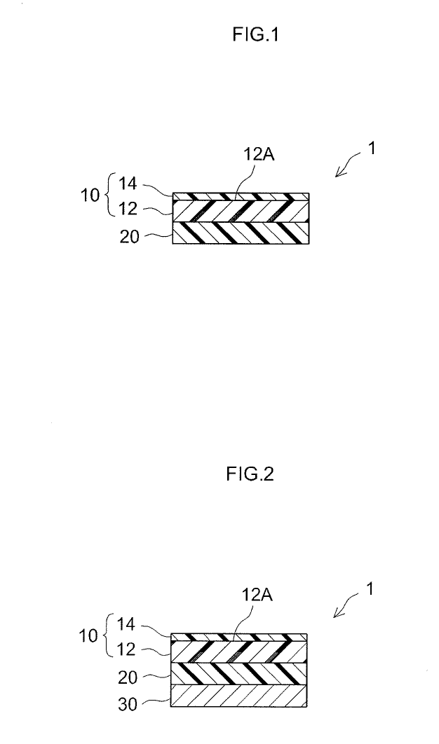

A typical example of constitution of a surface protection film having the transparent film disclosed herein as a support is shown schematically in FIG. 1. This surface protection film 1 is provided with a transparent film (support) 10 and a PSA layer 20. The transparent film 10 comprises a substrate layer 12 comprising a transparent resin film, and a back-face layer 14 having a thickness of 1 μm or less provided directly on a first face 12A thereof. The PSA layer 20 is provided on a surface among the transparent film 10 that is on the opposite side from the back-face layer 14. The surface protection film 1 is used by bonding this PSA layer 20 to an adherend (object to protect, for instance, the surface of an optical part such as a polarizer). Prior to use (that is to say, prior to bonding to the adherend), the protection film 1 may be of a morphology in which the surface of the PSA layer 20 (the face bonding to the adherend) is protected by a release liner 30, of which at least the PSA layer 20 side is a release face, typically as shown in FIG. 2. Alternatively, a morphology may be the surface protection film 1 wound in roll-form, causing the PSA layer 20 to be brought into contact with the back-face of the transparent film 10 (the surface of the back-face layer 14) and the surface thereof to be protected.

The substrate layer of the transparent film disclosed herein may be a resin film (substrate film) comprising various resin materials formed into the shape of a transparent film. Desirable as the resin materials are those that may constitute a substrate film having one, two or more properties which are excellent among transparency, mechanical strength, thermal stability, moisture-shielding properties, isotropy, and the like. For instance, a resin film constituted of a resin material having as a base resin (the main component among the resin components, that is to say, a component occupying 50% by mass or greater) a polyester polymer such as polyethylene terephthalate (PET), polyethylene naphthalate or polybutylene terephthalate, a cellulosic polymer such as diacetyl cellulose or triacetyl cellulose, a polycarbonate polymer, an acrylic polymer such as polymethyl methacrylate, or the like, can be used preferably as the substrate layer. As other examples of the resin material, those having as the base resin a styrene polymer such as polystyrene or acrylonitrile-styrene copolymer, an olefin polymer such as polyethylene, polypropylene, polyolefin having a cyclic or a norbornene structure, or ethylene-propylene copolymer, a polyvinyl chloride polymer, an amide polymer such as nylon 6, nylon 6,6 or aromatic polyamide, or the like, may be cited. As other examples of base resin, imide polymer, sulfone polymer, polyether sulfone polymer, polyether ether ketone polymer, polyphenylene sulfide polymer, vinyl alcohol polymer, vinylidene chloride polymer, vinyl butyral polymer, acrylate polymer, polyoxy methylene polymer, epoxy polymer, and the like, may be cited. The substrate layer may comprise a blend of two or more species of the polymers described above. The less anisotropic the optical characteristics (such as phase contrast), the more desirable the substrate layer. In particular, with a transparent film used as a support from in surface protection film for optical parts, it is advantageous to decrease the optical difference of the substrate layer. The substrate layer may be a monolayer structure or a structure in which a plurality of layers of different compositions are layered. A monolayer structure is typical.

While the thickness of the substrate layer can be selected suitably according to the purpose, in general, on the order of 10 μm to 200 μm is adequate, on the order of 15 μm to 100 μm is desirable, and 20 μm to 70 μm is more desirable, from the balance of workability such as strength and handleability with cost, external appearance inspectability and the like.

For the refractive index of the substrate layer, in general, on the order of 1.43 to 1.6 is adequate, and on the order of 1.45 to 1.5 is desirable. In addition, from the point of view of substrate transparency, it is desirable that the substrate layer has a light transmittance of 70% to 99%, and 80% to 97% (for instance 85% to 95%) is more desirable for the transmittance.

As necessary, various additives such as oxidation inhibitor, ultraviolet-light absorbent, antistatic component, plasticizer, colorant (pigment, dye and the like) may be mixed in the resin material constituting the substrate layer. A well-known or commonly used surface treatment may have been performed on a first face of the substrate layer (the surface on the side where the back-face layer is to be provided), such as, for instance, corona discharge treatment, plasma treatment, ultraviolet radiation treatment, acid treatment, alkaline treatment or coating of an undercoat agent. Such a surface treatment may be, for instance, a treatment for increasing the adhesiveness between the substrate layer and the back-face layer. A surface treatment such that a polar group such as a hydroxyl group (—OH group) is introduced on the surface of the substrate layer may be preferably adopted. In addition, in the surface protection film disclosed herein, the transparent film constituting the surface protection film may have a surface treatment similar to the above performed on a second face of the substrate layer thereof (the surface on the side where the PSA layer is formed). Such a surface treatment may be a treatment for increasing the adhesiveness between the transparent film (support) and the PSA layer (anchoring ability of the PSA layer).

On one face (the first face) of the substrate layer, the transparent film disclosed herein has a back-face layer having a thickness of 1 μm or less (typically from 0.02 μm to 1 μm). In the transparent film, the failure initiation load of the back-face layer is 50 mN or greater as measured by the scratch test described below. A transparent film that meets such a failure initiation load has an excellent resistance to scratch. For instance, in the evaluation of resistance to scratch described below, no falling debris from the back-face layer is observed visually. Consequently, the film is suitable as a support in a surface protection film (in particular, a surface protection film used during the manufacturing and transport of a polarizer and other optical parts). While the upper limit of the failure initiation load is not limited in particular, considering the balance with other properties (printability, back-face peel strength, light transmittance and the like), in general, a failure initiation load of 300 mN or less (for instance, 150 mN or less) is adequate. In one preferred mode of the transparent film disclosed herein, the failure initiation load is 50 mN to 300 mN (for instance, 50 mN to 150 mN).

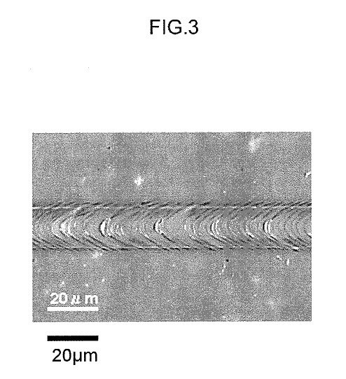

The failure initiation load is determined, for instance, under a measurement environment of 23° C. and 50% RH, using a conical diamond indenter having a tip curvature radius of 10 μm, by scratching the back-face of the transparent film (that is to say, the surface of the back-face layer) in one direction while increasing the load from 0 mN to 300 mN, as the load corresponding to the location where the length of the failure initiation point on this scratch trace has become greater than 2 μm (for a more concrete measurement method, refer to the Experimental Examples described below). An example of scratch trace obtained in the above condition is shown in FIG. 3.

The coefficient of friction of the back-face layer constituting the transparent film is 0.4 or less. With this, when a load is applied to the back-face layer (load that may give rise to a scratch mark), the load along the surface of the back-face layer is repelled and the frictional force due to the load is alleviated. Thus, events that give rise to a scratch mark can be prevented, which are caused by the back-face layer failing cohesively or the back-face layer being peeled-off (failing interfacially) from the substrate layer, due to the frictional force. While the lower limit of the coefficient of friction is not limited in particular, considering the balance with other properties (printability, back-face peel strength, light transmittance and the like), in general, a coefficient of friction of 0.1 or greater (typically 0.1 or greater but 0.4 or less) is adequate and 0.15 or greater (typically 0.15 or greater but 0.4 or less) is desirable.

A value that is determined, for instance, by scratching the back-face of a transparent film (that is to say, the surface of the back-face layer) at a perpendicular load of 40 mN under a measurement environment of 23° C. and 50% RH can be adopted as the coefficient of friction (for a more concrete measurement method, refer to the Experimental Examples described below). As techniques for decreasing (adjusting) the coefficient of friction so that the above coefficient of friction is realized, the method of including various lubricants (leveling agent and the like) in the back-face layer, the method of adjusting the conditions for the addition of a crosslinking agent and for film formation to increase the crosslink density of the back-face layer, and the like, can be adopted suitably.

In one preferred mode of the art disclosed herein, from the structural characteristic that the thickness of the back-face layer constituting the transparent film is 1 μm or less, a technique for improving the resistance to scratch is adopted, which is particularly effective in a transparent film provided with such a thin back-face layer. That is to say, when the back-face layer has a thickness to some extent (for instance, 5μm or greater), it is possible to increase the resistance to scratch by increasing the hardness of the back-face layer thereby improving the failure initiation load (in other words, by forming a layer having a strength that may resist to the load). However, the present inventors discovered that, with a transparent film having a back-face layer thickness of 1 μm or less, if the above technical idea is applied as-is, the improvement of resistance to scratch cannot be achieved precisely. The reason is thought to be that, with a transparent film in which the back-face layer has a thin structure, the load applied to the back-face layer is likely to reach the substrate layer, deforming the substrate layer.

As a result of studying in detail the failure behavior of the back-face layer for a transparent film provided with a thin back-face layer, the present inventors discovered that, in such a structure, when only the hardness of the thin back-face layer is increased without the substrate layer being changed, the deformation of the back-face layer cannot follow the deformation of the substrate layer with respect to the load, for which reason poor adhesion arises between the substrate layer and the back-face layer, decreasing the failure initiation load. Then, they found that, in order to prevent such an event and improve the resistance to scratch, it was effective to set the plasticity index ratio (Ps/Pb), which is defined as the ratio between the plasticity index Ps of the back-face layer and the plasticity index Pb of the substrate layer, to 1.5 or greater. Here, the plasticity indices Ps and Pb can be calculated, for instance, under a measurement environment of 23° C. and 50% RH, by perpendicularly indenting with a Berkovich (trigonal pyramid)-type diamond indenter having a tip curvature radius of 0.1 μm, measuring the indentation modulus and hardness at a depth of near 10 nm and dividing the value of the elastic modulus by the value of hardness (for a more concrete measurement example, refer to the Experimental Examples described below). It can be stated that the higher the plasticity index, the more likely the deformation with respect to the load. That is to say, a Ps/Pb of 1.5 or greater means that the back-face layer has such deformability that it may sufficiently follow the deformation of the substrate layer. A more satisfactory resistance to scratch may be realized by setting Ps/Pb to 2 or greater. While the upper limit of Ps/Pb is not particularly limited, considering the balance with other properties (coefficient of friction and the like), in general, 50 or less is adequate. In one preferred mode, Ps/Pb is 1.5 or greater but 3 or less. As another preferred mode, Ps/Pb may be 1.5 or greater but 50 or less (for instance, 10 or greater but 50 or less, and more preferably 20 or greater but 50 or less). The values of these preferred Ps/Pb, for instance, may be applied preferably to a transparent film in which the substrate layer comprises a polyester resin material (typically, PET resin material). The plasticity index of a generic PET film is approximately on the order of 10 to 20.

A transparent film constituted so as to meet both the preferred plasticity index ratio (Ps/Pb) and coefficient of friction disclosed herein may achieve the preferred failure initiation load readily. Against a frictional force received on the back-face thereof, such a transparent film may demonstrate a particularly high resistance to scratch, as it combines having the coefficient of friction described above, which may efficiently alleviate the frictional force, and having the plasticity index ratio described above, which may cause the back-face layer to follow sufficiently the deformation of the substrate layer due to the frictional force. Therefore, such a transparent film is suitable as a support in a surface protection film.

It is desirable for the back-face layer that the peel strength (back-face peel strength) is 2 N/19 mm or greater as measured by bonding a PSA tape to the back-face layer and peeling under the conditions of 0.3 m/minute peel speed and 180 degrees peel angle, and 3 N/19 mm or greater is more desirable. When applying the art disclosed herein to a surface protection film, having the peel strength described above is particularly of significance. If the peel strength is too low, the operation efficiency, when bonding a PSA tape to the release layer to remove the surface protection film from the adhered, sometimes tends to decrease. While the upper limit of the peel strength is not limited in particular, in general, 10 N/19 mm or less is desirable and, for instance, 6 N/19 mm or less is adequate, considering the balance with other properties (coefficient of friction and the like) and additionally, when unwinding the film after it was wound into a roll form, to prevent the event of a PSA attachment to the back-face thereof (adhesive residue). In one preferred mode of the art disclosed herein, the back-face peel strength is 2 N/19 mm to 10 N/19 mm (more preferably, 3 N/19 mm to 6 N/19 mm). The peel strength is obtained, for instance, by using a one-sided PSA tape manufactured by Nitto Denko Corporation, product named “No. 31B”, and measuring under an environment of 23° C. and 50% RH (for a more concrete measurement method, refer to the Experimental Examples described below).

Printability in the art disclosed herein indicates the quality that printing can be performed readily with an oil-based ink (for instance, using an oil-based marking pen). In processes such as fabrication and transport of an adherend (for instance, an optical part) that use a surface protection film, there is the demand of wishing to write on the surface protection film and display the identification number, or the like, of the adherend subjected to protection. Consequently, a transparent film that excels also in printability in addition to resistance to scratch, and a surface protection film provided with the transparent film are desirable. For instance, high printability towards an oil-based ink of a type in which the solvent is of the alcohol series and containing a pigment is desirable. In addition, that the printed ink is difficult to remove by friction or transfer (that is to say, excellent print adhesiveness) is desirable. The extent of the printability can be appreciated by, for instance, the printability evaluation described below.

The material of the resin constituting the back-face layer can be selected suitably so that the preferred failure initiation load and coefficient of friction (more preferably, also the plasticity index ratio) disclosed herein may be realized. It is desirable to select resins allowing a layer having excellent resistance to scratch and having sufficient strength to be formed, and having excellent light transparency. Such resins may be various types of resin, such as, heat curing resin, ultraviolet-light curing resin, electron beam curing resin, and two-component mixing-type resin.

As concrete examples of heat curing resin, those having as the base resin a polysiloxane series, a polysilazane series, a polyurethane series, an acryl-urethane series, an acryl-styrene series, a fluorine resin series, an acryl silicone series, an acrylic, a polyester series, a polyolefin series, and the like, may be cited. Among these, heat curing resins such as of the polyurethane series, the acryl-urethane series and the acryl-styrene series are desirable on the points of having high elasticity and ease of forming a layer having the preferred plasticity index ratio disclosed herein. In addition, heat curing resins such as of the polysiloxane series and the polysilazane series are desirable on the point of ease of forming a layer having high hardness. In addition, heat curing resins of the fluorine resin series are desirable on the points of containing a lubricating component in the molecular structure and ease of forming a layer having the preferred coefficient of friction disclosed herein. Resins having a soft segment and a hard segment are desirable. Here, a soft segment refers to a resin component having a flexible main chain structure or property, and a hard segment refers to a resin component having a rigid main chain structure or property (at least more rigid than the soft segment). The heat curing resins used in the formation of the back-face layer in the Samples A-4 to A-10 described below all correspond to resins having a soft segment and a hard segment. In addition, resins in the form of an emulsion, in which the resin component is dispersed in an aqueous solvent, may be used preferably. In the above emulsion form, even with a resin component having a large molecular weight and a long main chain, the viscosity and the concentration can be adjusted readily by dispersion in the aqueous medium as an emulsion particle. Such resin components are suited to forming coating films that have excellent plastic deformability. Consequently, with a resin (for instance, a heat curing resin) in emulsion form, a back-face layer demonstrating the preferred plasticity index ratio described above (high plasticity index ratio) may be realized adequately.

As concrete examples of ultraviolet-light curing resin, monomers, oligomers and polymers of various resins such as the polyester series, acrylic series, urethane series, amide series, silicone series and epoxy series, and mixtures thereof, may be cited. From the favorable ultraviolet-light curability and the ease of forming a layer with a high degree of hardness, an ultraviolet-light curing resin containing multi-functional monomers having two or more ultraviolet-light polymerizable functional groups (more preferably, three or more, for instance on the order of three to six) within one molecule, and/or oligomers thereof, may be adopted preferably. Acrylic monomers such as multi-functional acrylates and multi-functional methacrylates can be used preferably as the multi-functional monomers. From the point of view of adhesiveness to the substrate layer, it is more advantageous to use heat curing resins than ultraviolet-light curing resins.

The thickness of the back-face layer can be, for instance, close to 0.02 μm to 1 μm, and preferably close to 0.05 μm to 0.5 μm (for instance, 0.05 μm to 0.2 μm). If the thickness of the back-face layer is too large, the quality level of the external appearance, such as coloration and curling, sometimes become prone to decreasing due to the back-face layer. If the thickness of the back-face layer is too small, the desired resistance to scratch becomes difficult to realize. The thickness of the transparent film disclosed herein or of the layer constituting the surface film (for instance the back-face layer) can be appreciated by the technique of observing a at high resolution with a transmission electron microscopy (TEM), or the like, a sample obtained by pre-staining the back-face layer with heavy-metal, then, cutting this transparent film in the cross-sectional direction and surface-shaping. This technique may be applied preferably to layer having a thickness of close to 0.01 μm or greater. Regarding thinner layers, the approximate thickness thereof can be computed by constructing a calibration curve and performing calculations based on the correlation between various thickness detectors (for example, surface roughness meter, interferometric thickness gauge, infrared spectrometer, various X-ray diffractometers, and the like) and the thicknesses appreciated by electron microscope observations. In addition, using TEM sometimes also allows the layer constitution to be observed in the cross-sectional direction (the number layers in a layered structure and the thickness of each layer). In addition, when all the layers have a thickness of close to 0.1 μm or greater each, the layer constitution can also be investigated with an interferometric thickness gauge.

The back-face layer in the art disclosed herein, as necessary, can contain an additive such as a lubricant (leveling agent or the like), an antistatic component, a crosslinking agent, an oxidation inhibitor, a colorant (pigment, dye or the like), a fluidity adjuster (a thixotropic agent, a tackifier or the like), a film-formation helper or a catalyst (for instance, an ultraviolet-light polymerization initiator in a composition containing an ultraviolet-light curing resin). As crosslinking agents, generic crosslinking agents used in resin crosslinking such as of the isocyanate series, the epoxy series or the melamine series can be suitably selected and used. Given that adhesiveness may be improved by bonding with a hydroxyl group that may be present on the surface of the substrate layer, a crosslinking agent of the isocyanate series, for instance, may be adopted preferably. In particular, when the back-face layer is to be formed on a substrate layer that has been subjected to such a surface treatment whereby hydroxyl groups are introduced (for instance, a corona treatment), the use of an isocyanate series crosslinking agent is effective.

The back-face layer may be formed suitably by a technique comprising giving the substrate layer a liquid composition comprising the resin component and the additive to be used as necessary, dispersed or dissolved in an adequate solvent. For instance, the technique of coating the liquid composition (composition for back-face layer formation) to the substrate layer, drying, and as necessary carry out a curing treatment (heat treatment ultraviolet-light treatment or the like), may be preferably adopted. The solid content of the composition can be, for instance on the order of 0.1% by mass to 10% by mass, and in general on the order of 0.5% to 5% by mass is adequate. If the solid content too high, forming a thin and uniform back-face layer becomes sometimes difficult.

The solvent constituting the composition for back-face layer formation may be an organic solvent, water or a mixed solvent thereof. As the organic solvent, for instance, one, two or more species selected from methyl ethyl ketone, acetone, ethyl acetate, tetrahydrofuran (THF), dioxane, cyclohexanone, n-hexane, toluene, xylene, methanol, ethanol, n-propanol, isopropanol, and the like, can be used. In the art disclosed herein, it is desirable that the solvent constituting the composition for back-face layer formation is an aqueous solvent, from the point of view of alleviating the environmental burden or the like. Here “aqueous solvent” refers to water or a mixed solvent having water as the main component (component occupying 50% by volume or greater). A hydrophilic solvent is preferably used as component other than water constituting such an aqueous mixed solvent. For instance, one, two or more species selected from alcohols such as methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl 1-propanol, 2-methyl 1-butanol, n-hexanol and cyclohexanol can be preferably adopted.

When including a lubricant in the back-face layer, a generic fluorine or silicone lubricant can be preferably used as this lubricant. The use of a silicone lubricant is particularly desirable. As concrete examples of silicone lubricant, polydimethylsiloxane, polyether-modified polydimethylsiloxane, polymethyl alkylsiloxane, and the like, may be cited. A lubricant containing a fluorine compound or a silicone compound having an aryl group or an aralkyl group may be used (sometimes called printable lubricant given that it may give a resin film having suitable printability). In addition, a lubricant containing a fluorine compound or a silicone compound having a cross-linking reaction group may be used (reactive lubricant).

The amount of lubricant added can be close to 25 parts by mass or less (typically 0.01 parts by mass to 25 parts by mass) per 100 parts by mass of the resin component constituting the back-face layer, in general, preferably close to 15 parts by mass or less (typically 0.02 parts by mass to 15 parts by mass), can be for instance close to 0.5 parts by mass to 15 parts by mass, and can be more preferably close to 1 part by mass to 10 parts by mass. If the amount of lubricant added is excessive, sometimes, printability may tend to be insufficient and light transparency of the back-face layer may have a declining trend.

It is inferred that such a lubricant bleeds on the surface of the back-face layer, giving slipperiness to the surface, thereby decreasing the coefficient of friction. Consequently, an appropriate use of the lubricant allows the resistance to scratch to be improved through the decrease of the coefficient of friction. The lubricant may also contribute to decreasing thickness irregularities and attenuating interference fringes by uniformizing the surface tension of the back-face layer. This is particularly of significance in a surface protection film for an optical member. In addition, in a case where the resin component constituting the back-face layer is an ultraviolet-light curing resin, if a lubricant of the fluorine series or the silicone series is added thereto, when a composition for back-face layer formation is coated onto a substrate and dried, the lubricant bleeds on the surface of the coating film (the boundary surface with air), which suppresses the inhibition by oxygen of the curing during ultraviolet irradiation, allowing the ultraviolet-light curing resin to be cured sufficiently also at the outermost surface of the back-face layer.

The antistatic component is a component having the action of preventing electric charging of the transparent film or the surface protection film using the film. When including an antistatic component in the back-face layer, for instance, organic or inorganic electrically conductive substances, various antistatic agents, and the like, can be used as this antistatic component. Among them, the use of an organic electrically conductive substance is desirable. A transparent film provided with a back-face layer that has been given antistatic properties by including such an antistatic component is suitable as a surface protection film used in a fabrication or transport process, or the like, of products that dislike static electricity, such as, liquid crystal cells, semiconductor devices, and the like.

Various electrically conductive polymers can be preferably used as the organic electrically conductive substance. As examples of such electrically conductive polymers, polyaniline, polypyrrole, polythiophene, polyethylene imine, allylamine polymer, and the like, may be cited. Of such electrically conductive polymers, one species may be used alone, or two or more species may be used in combination. In addition, they may be used in combination with another antistatic component (inorganic electrically conductive substance, antistatic agent or the like). The amount of organic electrically conductive substance used (typically, electrically conductive polymer) can be for instance on the order of 0.2 parts by mass to 20 parts by mass with respect to 100 parts by mass of the resin component constituting the back-face layer, and in general on the order of 1 part by mass to 10 parts by mass is adequate.

As such electrically conductive polymers, those in the form of an aqueous solution or a water dispersion solution may be preferably used. For instance, by dissolving or dispersing in water an electrically conductive polymer having a hydrophilic functional group (may be synthesized by a technique such as copolymerizing a monomer having a hydrophilic functional group within the molecule), an aqueous solution or a water dispersion solution of the electrically conductive polymer can be prepared. Illustrative of the hydrophilic functional group are the sulfo group, the amino group, the amido group, the imino group, the hydroxyl group, the mercapto group, the hydrazino group, the carboxyl group, the quaternary ammonium group, the sulfate ester group (—O—SO₃H), the phosphoester group (for instance —O—PO(OH)₂), and the like. Such hydrophilic functional groups may form salts. As an example of commercial product of polyaniline sulfonic acid in the form of an aqueous solution or a water dispersion solution, the product named “aqua-PASS”, manufactured by Mitsubishi Rayon Co., Ltd., may be cited. In addition, as an example of commercial product of polythiophene in the form of an aqueous solution or a water dispersion solution, the product named “Denatron” series, manufactured by Nagase ChemteX Corporation, may be cited.

Illustrative of the electrically conductive polymers that may be preferably adopted in the art disclosed herein are polyanilines and polythiophenes. Polyanilines having a weight average molecular weight calculated as polystyrene (hereinafter noted “Mw”) of 50×10⁴ or less are desirable, and 30×10⁴ or less is more desirable. Polythiophenes having a Mw of 40×10⁴ or less are desirable, and 30×10⁴ or less is more desirable. In addition, it is desirable that the Mws of these electrically conductive polymers are in general 0.1×10⁴ or greater, and more preferably 0.5×10⁴ or greater. Electrically conductive polymers having such Mws are also desirable from the point of ease of preparation in the form of an aqueous solution or a water dispersion solution.

As the inorganic electrically conductive substances, microparticles comprising, for instance, tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof, can be used. Microparticles such as of ITO (indium oxide/tin oxide) and ATO (antimony oxide/tin oxide) may be used. It is desirable that the average particle size of the microparticle is, in general, roughly 0.1 μm or less (typically 0.01 μm to 0.1 μm). Of such inorganic electrically conductive substances (inorganic electric conducting materials), one species may be used alone, or two or more species may be used in combination. In addition, they may be used in combination with another antistatic component. The amount of inorganic electrically conductive substance used can be for instance on the order of 5 parts by mass to 500 parts by mass with respect to 100 parts by mass of the resin component constituting the back-face layer, and in general, on the order of 10 parts by mass to 500 parts by mass (for instance, 100 parts by mass to 500 parts by mass) is adequate.

As examples of the antistatic agent, cationic antistatic agents, anionic antistatic agents, amphoteric antistatic agents, non-ionic antistatic agents, ion-conductive polymers obtained by polymerizing or copolymerizing monomers having the above cationic, anionic or amphoteric ion-conductive group, and the like, may be cited. Of such antistatic agents, one species may be used alone, or two or more species may be used in combination. In addition, they may be used in combination with another antistatic component. The amount of antistatic agent uses can be, for instance, close to 0.5 parts by mass to 50 parts by mass with respect to 100 parts by mass of the resin component constituting the back-face layer, and in general 1 part by mass to 30 parts by mass is adequate.

As examples of cationic antistatic agent, those containing a cationic functional group such as a quaternary ammonium salt, a pyridinium salt, or a primary, a secondary or a tertiary amino group, may be cited. More concretely: acrylic copolymers having a quaternary ammonium group such as alkyl trimethylammonium salt, acyloyl amidopropyl trimethylammonium methosulfate, alkylbenzyl methyl ammonium salt, acylcholine chloride or polydimethylaminoethyl methacrylate; styrene copolymers having a quaternary ammonium group such as polyvinyl benzyl trimethylammonium chloride; diallylamine copolymers having a quaternary ammonium group such as polydiallyl dimethylammonium chloride; and the like, are illustrative.

As examples of anionic antistatic agent, those containing an anionic functional group such as sulfonate, sulfate ester salt, phosphonate or phosphoester salt may be cited. More concretely, alkyl sulfonate, alkyl benzene sulfonate, alkyl sulfate ester salt, alkyl ethoxysulfate ester salt, alkyl phosphoester salt, sulfonic acid group-containing styrene copolymers, and the like, are illustrative.

As examples of amphoteric antistatic agent, alkyl betaine and derivatives thereof, imidazoline and derivatives thereof, and alanine and derivatives thereof, may be cited. More concretely, alkyl betaine, alkyl imidazolium betaine, carbobetaine graft copolymer, and the like, are illustrative.

As examples of non-ionic antistatic agent, amino alcohol and derivatives thereof, glycerin and derivatives thereof, and polyethylene glycol and derivatives thereof may be cited. More concretely, fatty acid alkylol amide, di(2-hydroxyethyl)alkyl amine, polyoxyethylene alkyl amine, glycerin fatty acid ester, polyoxyethylene glycol fatty acid ester, sorbitan fatty acid ester, polyoxysorbitan fatty acid ester, polyoxyethylene alkylphenyl ether, polyoxyethylene alkyl ether, polyethylene glycol, polyoxyethylene diamine, copolymer comprising polyether, polyester and polyamide, methoxy polyethylene glycol (meth)acrylate, and the like, are illustrative.

As methods for giving antistatic properties to a transparent film, alternatively to the method of including an antistatic component in the back-face layer as described above, or in addition to the method, the method of including an antistatic component in the substrate layer, the method of providing an antistatic layer on the first face and/or the second face of the substrate layer, and the like, can be adopted.

The method of including an antistatic component in the substrate layer may be preferably carried out, for instance, by forming a resin material in which an antistatic component is mixed (kneaded-in) into the shape of a film to constitute the substrate layer. As antistatic components used in such a method, the same materials as those illustrated above as antistatic components to be included in the back-face layer, or the like, can be adopted. The mixing amount of such antistatic components can be, for instance, close to 20% by mass or less (typically 0.05% by mass to 20% by mass) with respect to the total mass of the substrate layer, and in general, a range of 0.05% by mass to 10% by mass is adequate. As methods for kneading-in the antistatic component, there is no particular limitation as long as they are methods that can homogeneously mix the antistatic agent into the resin material for substrate layer formation and, for instance, kneading methods that use a heat roll, a Banbury mixer, a pressurized kneader, a biaxial kneader, or the like, may be cited.

The method of providing an antistatic layer on the first face (on the back-face side, that is to say, between the substrate layer and the back-face layer) and/or the second face (on the PSA layer side) of the substrate layer may be preferably carried out by coating the substrate layer (preferably, a pre-formed resin film) with a coating agent for static charge prevention containing an antistatic component and a resin component to be used as necessary. As the antistatic components, the same materials as those illustrated above as antistatic components to be included in the back-face layer, or the like, can be adopted. The use of an electrically conductive polymer or an antistatic agent is desirable. As the resin component used in the coating agent for static charge prevention, for instance, general-purpose resins such as polyester resin, acrylic resin, polyvinyl resin, urethane resin, melamine resin and epoxy resin can be used. In addition, the coating agent for static charge prevention may contain as a crosslinking agent for the resin component, a compound of the methylolated or alkylolated melamine series, the urea series, the glyoxal series or the acrylamide series, an epoxide compound, an isocyanate series compound or the like. In the case of a high molecular weight-type antistatic component (typically, electrically conductive polymer) the use of the resin component may be omitted.

As methods for coating the coating agent for static charge prevention, well-known coating method can be used suitably. As concrete examples, roll-coating method, gravure-coating method, reverse-coating method, roll-brush method, spray-coating method, air-knife coating method, impregnation method and curtain-coating method may be cited. For the thickness of the antistatic layer, in general, close to 0.01 μm to 1 μm is adequate, and on the order of close to 0.015 μm to 0.1 μm is desirable.

In one preferred mode of the art disclosed herein, the back-face layer is provided directly on the first face of the substrate layer. Given the excellent adhesiveness between the substrate layer and the back-face layer, a transparent film of such a constitution is desirable since it is likely to meet the preferred failure initiation load described above. Consequently, when providing the antistatic layer on the surface of the substrate layer, it is desirable to provide the antistatic layer only on the second face of the substrate layer.

As the PSA layer constituting the surface protection film disclosed herein, one can be formed suitably by using a PSA composition allows a PSA layer to be formed, provided with qualities that are suited to the surface protection film (peel strength, non-contaminability and the like, with respect to the adherend surface). For instance, the method of providing such a PSA composition directly to the substrate layer and drying or curing to form a PSA layer (direct method), the method of providing a PSA composition on the surface of a release liner (release face) and drying or curing to form a PSA layer on the surface, and bonding this PSA layer matchingly to the substrate layer to transfer the PSA layer onto the substrate layer (transfer method), and the like, can be adopted. From the point of view of the anchoring ability of the PSA layer, in general, the direct method may be adopted preferably. When providing (typically, coating) the PSA composition, various methods conventionally well-known in the field of PSA sheet can be adopted suitably, such as, the roll-coating method, the gravure-coating method, the reverse-coating method, the roll-brush method, the spray-coating method, the air-knife coating method, and the method of coating with a die coater. Although not to be limited in particular, the thickness of the PSA layer can be, for instance, on the order of close to 3 μm to 100 μm, and in general, on the order of close to 5 μm to 50 μm is desirable. As methods for obtaining the surface protection film disclosed herein, either of the method of forming the PSA layer on a substrate layer (that is to say a transparent film) provided beforehand with a back-face layer, and the method of forming the back-face layer after providing a PSA layer on the substrate layer, can be adopted. In general, the method of providing a PSA layer to the transparent film is desirable.

With the purpose of protecting the PSA face (the face on the side of the PSA layer that is to be bonded to the adherend), the surface protection film disclosed herein may be supplied, as necessary, in a form comprising a release liner bonded matchingly onto the PSA face (in the form of a surface protection film with a release liner). As substrates constituting the release liner, papers, synthetic resin films, and the like, can be used; from the point of excellent surface smoothness, synthetic resin films are used suitably. For instance, a resin film comprising the same resin material as the substrate layer can be used preferably as the substrate of the release liner. The thickness of the release liner can be, for instance, close to 5 μm to 200 μm, and in general, on the order of close to 10 μm to 100 μm is desirable. A parting or anti-soiling treatment may be performed on the face of the release liner to be bonded matchingly to the PSA layer, using a conventionally well-known parting agent (for instance, of the silicone series, the fluorine series, the long chain alkyl series, the fatty acid amide series or the like), silica powder, or the like.

While a number of experimental examples related to the present invention will be described below, the present invention is not intended to be limited to what is indicated in such concrete examples. In the descriptions below, “parts” and “%” are mass-based, unless explicitly stated otherwise. In addition, the properties in the descriptions below were respectively measured or evaluated in the following manner.

### 1. Failure Initiation Load

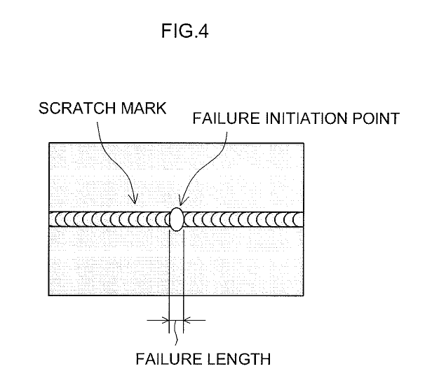

Nano-Scratch Tester manufactured by CSM Instruments SA was used as the device for measuring the failure initiation load. The PSA face of each surface protection film sample was bonded to a slide glass and the sample was immobilized on the stage of the measurement device so that the back-face layer was facing up. Then, a scratch test was carried out, under a measurement environment of 23° C. and 50% RH, using a cantilever ST-150 equipped with a conical diamond indenter (tip curvature radius: 10 μm) to scratch in one direction while increasing the load (scratch load) from 0 mN to 300 mN in the continuous load mode of the device. Using a light microscope (manufactured by Nikon) supplied with the device, a sample subjected to the scratch test was observed with a 20× objective lens for a scratch trace on its surface. Then, as shown in FIG. 4, the first location on the scratch trace where the back-face layer was peeled over longer than 2 μm in the scratch direction served as the failure initiation point, and the scratch load corresponding to the center of the length, with respect to the scratch direction, of this failure initiation point (failure length) served as the failure initiation load.

### 2. Coefficient of Friction

Under a measurement environment of 23° C. and 50% RH, in the constant load mode of the Nano-Scratch Tester (perpendicular load: 40 mN±3 mN), the surface (on the back-face layer side) of each sample bonded to the slide glass in a similar manner to above was scratched over a length of 5 mm, and the mean value of the coefficient of friction at this time served as the coefficient of friction of the back-face layer. The coefficient of friction is calculated as the ratio between the frictional force and the load in the perpendicular direction to the sample surface (that is to say, coefficient of friction=frictional force/load).

### 3. Plasticity Index

Plasticity index was evaluated using the Nano Indenter, Model “DCM SA2”, manufactured by MTS Systems Corporation. That is to say, in a similar manner to above, each sample was bonded to a slide glass and immobilized on the stage so that the back-face layer thereof was facing up. The indentation modulus and hardness at depth of near 10 nm were measured by perpendicularly indenting to a maximum depth of 500 nm using a Berkovich (trigonal pyramid)-type diamond indenter (tip curvature radius: 0.1 μm) under a measurement environment of 23° C. and 50% RH. Then, the measurement value of the elastic modulus was divided by the measurement value of hardness to calculate the plasticity index (that is to say, plasticity index=elastic modulus/hardness).

### 4. Plasticity Index Ratio

For each sample (with a back-face layer provided on the substrate), the plasticity index Ps determined by 3. above was divided by the plasticity index Pb of the substrate (substrate having no back-face layer) constituting the sample to calculate the plasticity index ratio (that is to say, plasticity index ratio=Ps/Pb).

### 5. Peel Strength Measurement

Each surface protection film sample was cut to a size of 70 mm in width and 100 mm in length to serve as an adherend. A one-sided PSA tape (No. 31B, manufactured by Nitto Denko Corporation) was cut to a size of 19 mm in width and 100 mm in length, and the PSA face of the PSA tape was pressure-bonded on the back-face layer of the adherend at a pressure of 0.25 Mpa and a speed of 0.3 m/minute. This was left under an environment of 23° C. and 50% RH for 30 minutes, then, under the same environment, using a universal tensile tester, the PSA tape was peeled-off from the adherend under the conditions of 0.3 m/minute peel speed and 180 degrees peel angle, and the peel strength at this time was measured.

### 6. Evaluation of Resistance to Scratch

In a similar manner, each sample was bonded to a slide glass, and each sample was scratched at a load of 300 g on a precision balance using the edge of a coin (a new 10-yen coin was used) under a measurement environment of 23° C. and 50% RH. This scratch trace was observed with a light microscope, and the evaluation was indicated by cross (x) when the presence of falling debris from the back-face layer was observed, and indicated by circle (O) when the presence of the falling debris was not observed.

### 7. Substrate Adhesiveness

A small amount of blue pigment was mixed into a composition for back-face layer formation to prepare each sample. A checkerboard grid peel test was performed, comprising producing, on the surface of these samples on the side where the back-face layer is formed, 10 squares×10 squares (100 squares total) cut marks spaced vertically and horizontally by 1 mm each, pressure-bonding from above this a one-sided PSA tape (No. 31B, 19 mm in width, manufactured by Nitto Denko Corporation) under the same conditions as the peel strength measurement, and then, manually peeling-off the one-sided PSA tape, under a measurement environment of 23° C. and 50% RH. In this checkerboard grid test, the evaluation was 1 point when a loss of 50 squares or more was observed, 2 points when the loss was 11 squares or more but 49 squares or less, and 3 points when the loss was 10 squares or less.

### 8. Printability (Print Adhesiveness) Evaluation

Printing was performed on the back-face layer using Xstamper manufactured by Shachihata Inc, under a measurement environment of 23° C. and 50% RH. From above this print, a cellophane PSA tape manufactured by Nichiban Co., Ltd. (product No. 405, 19 mm in width) was bonded and then peeled-off under the conditions of 30 m/minute peel speed and 180 degrees peel angle. The evaluation was indicated by O when 50% or more of the print surface area was peeled away, triangle (Δ) when more than 25% but less than 50% of the print surface area was peeled away, and O when 75% or more of the print surface area remained without being peeled away, by visual evaluation.

### 9. Evaluation of Whitening and Irregularities

Whitening evaluation: the haze value of each sample was measured with a haze meter (manufactured by Murakami Color Research Laboratory Co., Ltd., model “HM-150”), and a haze value of 5 or less was accepted.

Irregularity evaluation: the external appearance sample was visually evaluated in a bright room, when no abnormal external appearance such as a stripe was observed, the sample was accepted.

Whitening/irregularities was evaluated as O for a sample accepted in both the whitening and the irregularity evaluations, Δ when rejected for either one of the evaluations, and x when rejected for both.

### 10. Curl Evaluation

Each sample was cut to a 100 mm square size and stored for one day under the environment of 40° C. and 90% RH. This was left along on a horizontal plane in an orientation where the back-face layer was the top face, and the height by which an extremity of the sample curled and lifted from the plane was measured. The evaluation was indicated by O when the height of the portion that lifted the greatest (maximum lift height) was 3 mm or less, and x when the maximum lift height exceeded 3 mm.

### Experimental Example 1

(Sample A-1)

A urethane acrylate ultraviolet-light curing resin (manufactured by The Nippon Synthetic Chemical Industry Co., Ltd., product named “SHIKOH UV-1700B”; hereafter, may also be noted “Resin R1”) and a radical polymerization initiator (manufactured by Ciba Geigy, product named “Darocur 1173”) were mixed so that the solid content mass ratio was 100:4 and dissolved in a solvent having toluene as the main component to prepare a Coating Solution B-1 with a solid content concentration of 30%.

A 38 μm-thick transparent polyethylene terephthalate (PET) film (hereafter, may also be noted “Substrate F1”) corona-treated on a first face was used as a substrate. The first face of this Substrate F1 (the corona-treated face) was coated with the Coating Solution B-1 so that the thickness after drying was 8 μm (as observed by TEM; idem hereinafter), and a curing treatment of irradiating with ultraviolet-light was carried out to form a back-face layer. The ultraviolet-light irradiation was carried out using a metal halide lamp under a condition of 450 mJ/cm². In this way, a Transparent Film C-1 provided with a back-face layer on the first face of the Substrate F1 (the corona-treated face) was obtained.

A parting sheet was prepared, comprising a PET film release-treated on a first face with a silicone release treatment agent, and a 25 μm-thick acrylic PSA layer was formed on the release face of the parting sheet (the release-treated face). This PSA layer was transferred onto a second face of the Transparent Film C-1 (the face provided with no back-face layer) to prepare a surface protection film Sample A-1. The plasticity index Ps of this Sample A-1, when determined by the method described above, was 22.6 (elastic modulus: 6.6 Gpa; hardness: 0.29 GPa). The plasticity index Pb of the PET film used here was 13.6 (elastic modulus: 4.8 Gpa; hardness: 0.35 GPa). In addition, the PET film had a refractive index of 1.63 and a light transmittance of 89%.

(Sample A-2)

The Coating Solution B-1 was further diluted with the above solvent to prepare a Coating Solution B-2 with a solid content concentration of 1%. Except the point that this Coating Solution B-2 was coated so that the thickness after drying was 0.1 μm, a Transparent Film C-2 was obtained in a similar manner to the preparation of the Sample A-1, and similarly, a PSA layer was transferred to prepare a surface protection film Sample A-2. The plasticity index Ps of this Sample A-2 was 14.4 (elastic modulus: 4.8 GPa; hardness: 0.33 GPa).

(Sample A-3)

Except the point that 5 parts (calculated as solid contents) of lubricant was mixed per 100 parts of solid contents in Resin R1, a Coating Solution B-3 was prepared in a similar manner to the preparation of the Coating Solution B-2. Here, a polyether-modified polydimethylsiloxane leveling agent (manufactured by BYK Chemie, product named “BYK-333”; hereafter, may also be noted “Lubricant L1”) was used as the lubricant. Except the point that this Coating Solution B-3 was coated so that the thickness after drying was 0.1 μm, a Transparent Film C-3 was obtained in a similar manner to the preparation of the Sample A-1, and similarly, a PSA layer was transferred to prepare a surface protection film Sample A-3. The plasticity index Ps of this Sample A-3 was 13.2 (elastic modulus: 4.4 GPa; hardness: 0.34 GPa).

For the above samples, a summary of the constitution of the back-face layer is shown in Table 1, and the results of the various measurements and evaluations described above are shown in Table 2.

TABLE 1

| | Constitution of the back-face layer | | |
|---|---|---|---|
| | | Lubricant amount | Thickness |
| Sample | Resin species | (parts) | (μm) |
| A-1 | R1 | None | 8 |
| A-2 | R1 | None | 0.1 |
| A-3 | R1 | 5 | 0.1 |

TABLE 2

| | Failure | | Plasticity | Peel | | Substrate | | | |
|---|---|---|---|---|---|---|---|---|---|
| Sample (back-face | initiation | Coefficient | index | strength | Resistance | adhesiveness | | Whitening/ | |
| layer thickness) | load (mN) | of friction | ratio | (N/19 mm) | to scratch | (points) | Printability | irregularities | Curl |
| A-1 (8 μm) | 100.0 | 0.19 | 1.67 | 4.1 | ∘ | 1 | ∘ | ∘ | x |
| A-2 (0.1 μm) | 28.0 | 0.51 | 1.06 | 4.9 | x | 1 | Δ | ∘ | ∘ |
| A-3 (0.1 μm) | 34.0 | 0.35 | 0.97 | 3.8 | x | 1 | Δ | Δ | ∘ |

As shown in these tables, while the Sample A-1, in which the back-face layer had a thickness of 8 μm, demonstrated a satisfactory resistance to scratch, in the Sample A-2, in which the thickness of the back-face layer was 0.1 μm with the same composition, the resistance to scratch was insufficient. The reason is thought to be that, with a constitution in which the thickness of the back-face layer is small, if the hardness of the back-face layer is too high compared to the substrate layer (and therefore the plasticity index ratio is too small), it is likely to be damaged when subjected to an external force (frictional force) due to an inability to follow the deformation of the substrate layer. In addition, compared to Sample A-1, the coefficient of friction of A-2 is high, which is assumed to be due to the load related to the damage on the back-face layer being detected in the measurement of the coefficient of friction. With the Sample A-3, in which 5 parts of lubricant was mixed, although a decrease in the coefficient of friction and an improvement in the failure initiation load were observed compared to A-2, realization of the desired resistance to scratch was not achieved. In addition, as whitening/irregularities became noticeable when the mixing amount of the lubricant was increased, mixing 5 parts or greater was determined to be inadequate.

### Experimental Example 2

(Sample A-4)

A water-dispersed polyurethane heat curing resin (manufactured by Nippon Polyurethane, product named “Takelac WS-4100”; hereafter, may also be noted “Resin R2”) was diluted with distilled water to prepare a Coating Solution B-4 with a solid content concentration of 20%. This Coating Solution B-4 was coated onto a first face of the Substrate F1 (the corona-treated face) so that the thickness after drying was 8 μm and heat cured to obtain a Transparent Film C-4 provided with a back-face layer on the first face of the Substrate F1. In a similar manner to above, a PSA layer was transferred onto a second face of this Transparent Film C-4 to prepare a surface protection film Sample A-4. The plasticity index Ps of this Sample A-4 was 21.8 (elastic modulus: 3.4 GPa; hardness: 0.16 GPa).

(Sample A-5)

The Coating Solution B-4 was further diluted with distilled water to prepare a Coating Solution B-5 with a solid content concentration of 1%. Except the point that this Coating Solution B-5 was coated so that the thickness after drying was 0.1 a Transparent Film C-5 was obtained in a similar manner to the preparation of the Sample A-4, and similarly, a PSA layer was transferred to prepare a surface protection film Sample A-5. The plasticity index Ps was 17.6 (elastic modulus: 4.9 GPa; hardness: 0.28 GPa).

(Sample A-6)

Except the point that 5 parts (calculated as solid contents) of Lubricant L1 was mixed per 100 parts of solid contents in Resin R2, a Coating Solution B-6 was prepared in a similar manner to the preparation of the Coating Solution B-5. Except the point that this Coating Solution B-6 was coated so that the thickness after drying was 0.1 μm, a Transparent Film C-6 was obtained in a similar manner to the preparation of the Sample A-4, and similarly, a PSA layer was transferred to prepare a surface protection film Sample A-6. The plasticity index Ps was 29.5 (elastic modulus: 2.5 GPa; hardness: 0.09 GPa).

(Sample A-7)

Except the point that the mixing amount of Lubricant L1 was 10 parts (calculated as solid content) per 100 parts of solid contents in Resin R2, a Transparent Film C-7 was obtained in a similar manner to the preparation of the Sample A-6, and similarly, a PSA layer was transferred to prepare a surface protection film Sample A-7. The plasticity index Ps was 37.7 (elastic modulus: 2.1 GPa; hardness: 0.05 GPa).

(Sample A-8)

A water-dispersed acryl-styrene heat curing resin (manufactured by DIC Corporation, product named “VONCOAT CG-8490”; hereafter, may also be noted “Resin R3”) was diluted with distilled water to prepare a Coating Solution B-8 with a solid content concentration of 3%. This Coating Solution B-8 was coated onto a first face of the Substrate F1 (the corona-treated face) so that the thickness after drying was 0.1 μm and heat cured to obtain a Transparent Film C-8 provided with a back-face layer on the first face of the Substrate F1. In a similar manner to above, a PSA layer was transferred onto a second face of this Transparent Film C-8 to prepare a surface protection film Sample A-8. The plasticity index Ps of this Sample A-8 was 361.7 (elastic modulus: 3.61 GPa; hardness: 0.01 GPa).

(Sample A-9)

The Resin R3, the Lubricant L1, and, as an antistatic component, an electrically conductive polymer (manufactured by Mitsubishi Rayon Co., Ltd., water dispersion solution of polyaniline sulfonic acid having a weight average molecular weight of approximately 15×10⁴, product named “aqua-PASS”; hereafter, may also be noted “AS1”) were mixed so that the solid content mass ratio was 100:2:6 and diluted with distilled water to prepare a Coating Solution B-9 with a solid content concentration of 3%. Except the point that this Coating Solution B-9 was coated so that the thickness after drying was 0.1 μm, a Transparent Film C-9 was obtained in a similar manner to the preparation of the Sample A-8, and similarly, a PSA layer was transferred to prepare a surface protection film Sample A-9. The plasticity index Ps of this Sample A-9 was 298 (elastic modulus: 2.7 GPa; hardness: 0.009 GPa).

(Sample A-10)

The Resin R3, the Lubricant L1, and, as an antistatic component, an electrically conductive filler (a tin oxide solution manufactured by Taki Chemical Co., Ltd., product named “Ceramace S-8”; hereafter, may also be noted “AS2”) were mixed so that the solid content mass ratio was 100:2:300 and diluted with distilled water to prepare a Coating Solution B-10 with a solid content concentration of 3%. Except the point that this Coating Solution B-10 was coated so that the thickness after drying was 0.1 μm, a Transparent Film C-10 was obtained in a similar manner to the preparation of the Sample A-8, and similarly, a PSA layer was transferred to prepare a surface protection film Sample A-10. The plasticity index Ps was 15.4 (elastic modulus: 6.1 GPa; hardness: 0.40 GPa).

For these samples, a summary of the constitution of the back-face layer is shown in Table 3, and the results of the various measurements and evaluations described above are shown in Table 4.

TABLE 3

| | Constitution of the back-face layer | | | | |
|---|---|---|---|---|---|
| | | | Lubricant | Antistatic component | |
| | Resin | Thickness | amount | | Amount |
| Sample | species | (μm) | (parts) | Species | (parts) |
| A-4 | R2 | 8.0 | — | — | — |
| A-5 | R2 | 0.1 | — | — | — |
| A-6 | R2 | 0.1 | 5 | — | — |
| A-7 | R2 | 0.1 | 10 | — | — |
| A-8 | R3 | 0.1 | — | — | — |
| A-9 | R3 | 0.1 | 2 | AS1 | 6 |
| A-10 | R3 | 0.1 | 2 | AS2 | 300 |

TABLE 4

| | Failure | | Plasticity | Peel | | Substrate | | | |
|---|---|---|---|---|---|---|---|---|---|
| Sample (back-face | initiation | Coefficient | index | strength | Resistance | adhesiveness | | Whitening/ | |
| layer thickness) | load (mN) | of friction | ratio | (N/19 mm) | to scratch | (points) | Printability | irregularities | Curl |
| A-4 (8 μm) | 45.0 | 0.35 | 1.61 | 5.2 | x | 2 | ∘ | Δ | ∘ |
| A-5 (0.1 μm) | 27.5 | 0.52 | 1.30 | 5.6 | x | 2 | ∘ | Δ | ∘ |
| A-6 (0.1 μm) | 100.0 | 0.33 | 2.17 | 4.5 | ∘ | 2 | ∘ | ∘ | ∘ |
| A-7 (0.1 μm) | 66.5 | 0.38 | 2.78 | 3.3 | ∘ | 2 | ∘ | ∘ | ∘ |
| A-8 (0.1 μm) | 54.3 | 0.49 | 27 | 5.8 | ∘ | 3 | ∘ | ∘ | ∘ |
| A-9 (0.1 μm) | 57.3 | 0.35 | 22 | 5.9 | ∘ | 3 | ∘ | ∘ | ∘ |
| A-10 (0.1 μm) | 22.0 | 0.44 | 1.13 | 5.6 | x | 1 | ∘ | Δ | ∘ |

As shown in these tables, according to Samples A-6 and A-7, in which the coefficient of friction was adjusted to 0.4 or less by mixing a lubricant in the back-face layer composition of A-5, and for which the plasticity index ratio was 2 or greater, although the back-face layer was as thin as 0.1 μm, high failure initiation loads of 50 mN or greater were accomplished, and an excellent resistance to scratch was realized. In addition, by similarly demonstrating a coefficient of friction of 0.4 or less and a plasticity index ratio of 2 or greater, a high failure initiation load and an excellent resistance to scratch were realized also in Samples A-8 and A-9, in which the resin compositions of the back-face layer were different from those of A-6 and A-7. These Samples A-6 to A-9 all had adequate degrees of peel strength from 3 N/19 mm to 6 N/19 mm and displayed satisfactory substrate adhesiveness and printability. In addition, no whitening/irregularities were observed, and the extent of the curl was also small. Samples A-8 and A-9, for which the plasticity index ratio falls in the range of 10 to 50 (and more concretely 20 to 50), demonstrated particularly satisfactory substrate adhesiveness.

Meanwhile, Sample A-5, which omitted the lubricant from Sample A-6, with a high coefficient of friction and a low failure initiation load, lacked resistance to scratch, probably due to the plasticity index ratio being too small, or the like. With the back-face layer composition related to this Sample A-5, the resistance to scratch was insufficient even in Sample A-4 which had a large thickness. In addition, Sample A-10, which had a different species of antistatic component from Sample A-9, with a high coefficient of friction and a low failure initiation load, lacked resistance to scratch, probably due to the plasticity index ratio being too small, or the like.

### INDUSTRIAL APPLICABILITY

The transparent film disclosed herein may be used preferably in an application such as a support in various surface protection films. In addition, during fabrication or during transport, or the like, of an optical member used as a structural component of a liquid crystal display panel, a plasma display panel (PDP), an organic electro-luminescence (EL) display, or the like, the surface protection film disclosed herein is suitable to an application for protecting the optical member. In particular, it is useful as a surface protection film applied to an optical member for a liquid crystal display panel, such as, a polarizer (polarization film), a wave plate, a phase contrast plate, an optical compensation film, a brightness improvement film, a light diffusion sheet or a reflective sheet.

### EXPLANATION OF REFERENCE NUMERALS

1: Surface protection film
10: Transparent film
12: Substrate layer
14: Back-face layer
20: PSA layer
30: Release liner

1. A transparent film having a substrate layer formed of a transparent resin material, and a back-face layer provided on a first face of the substrate layer, wherein
the back-face layer has a thickness of 1 μm or less,
a failure initiation load of the back-face layer is 50 mN or greater in a scratch test, and
the back-face layer exhibits a friction coefficient of 0.4 or less.

2. The transparent film according to claim 1, wherein a plasticity index Ps is determined by indenting the back-face layer perpendicularly with a Berkovich-type diamond indenter having a tip curvature radius of 0.1 μm and measuring an indentation modulus and hardness at a depth of 10 nm, and then dividing the elastic modulus by the hardness, and a plasticity index Pb is determined in the same way as the plasticity index Ps is determined for the substrate layer such that a ratio (Ps/Pb) of the plasticity index Ps to the plasticity index Pb is 1.5 or greater.

3. The transparent film according to claim 1, wherein peel strength is 2 N/19 mm or greater as measured by bonding a pressure-sensitive adhesive tape to the back-face layer and peeling the pressure-sensitive adhesive tape from the back-face layer under conditions of a 0.3 in/minute peel speed and a 180 degrees peel angle.

4. The transparent film according to claim 1, wherein the back-face layer has a monolayer structure and is directly provided on the substrate layer.

5. The transparent film according to claim 1, wherein the back-face layer is formed of a resin material containing a lubricant.

6. The transparent film according to claim 1, wherein the back-face layer is formed of a resin material containing an antistatic component.

7. The transparent film according to claim 6, wherein the antistatic component is an electrically conductive polymer.

8. The transparent film according to claim 1, wherein base resin constituting the substrate layer is polyethylene terephthalate resin or polyethylene naphthalate resin.

9. A surface protection film comprising:
the transparent film according to claim 1; and
a pressure-sensitive adhesive layer provided on a surface of the transparent film, the surface being on an opposite side to the back-face layer.

10. The transparent film according to claim 2, wherein peel strength is 2 N/19 mm or greater as measured by bonding a pressure-sensitive adhesive tape to the back-face layer and peeling the pressure-sensitive adhesive tape from the back-face layer under conditions of a 0.3 m/minute peel speed and a 180 degrees peel angle.

11. The transparent film according to claim 2, wherein the back-face layer has a monolayer structure and is directly provided on the substrate layer.

12. The transparent film according to claim 2, wherein the back-face layer is formed of a resin material containing a lubricant.

13. The transparent film according to claim 2, wherein the back-face layer is formed of a resin material containing an antistatic component.

14. The transparent film according to claim 13, wherein the antistatic component is an electrically conductive polymer.

15. The transparent film according to claim 2, wherein base resin constituting the substrate layer is polyethylene terephthalate resin or polyethylene naphthalate resin.

16. A surface protection film comprising:
the transparent film according to claim 2; and
a pressure-sensitive adhesive layer provided on a surface of the transparent film, the surface being on an opposite side to the back-face layer.

17. The transparent film according to claim 3, wherein the back-face layer has a monolayer structure and is directly provided on the substrate layer.

18. The transparent film according to claim 3, wherein the back-face layer is formed of a resin material containing a lubricant.

19. The transparent film according to claim 3, wherein the back-face layer is formed of a resin material containing an antistatic component.

20. The transparent film according to claim 19, wherein the antistatic component is an electrically conductive polymer.
